(19) United States
(12) Patent Application Publication
(10) Pub. No.: US 2025/0175062 A1
(43) Pub. Date: May 29, 2025

(54) Device for Grounding a Shaft

(71) Applicant: ZF Friedrichshafen AG, Friedrichshafen (DE)

(72) Inventor: Michael Griesbach, Tettnang (DE)

(21) Appl. No.: 18/962,795

(22) Filed: Nov. 27, 2024

(30) Foreign Application Priority Data
Nov. 28, 2023 (DE) 102023211837.8

(51) Int. Cl. H02K 11/40; H02K 7/00; H02K 9/193; H02K 11/33

(52) U.S. Cl. CPC H02K 11/40; H02K 7/003; H02K 11/33; H02K 9/193; H02K 2205/03

(57) ABSTRACT

An arrangement for grounding rotor shafts of electric machines includes a bearing, a grounding hub, and a spring element. The grounding hub is configured to be electrically conductively connected at a first end to an electrical ground, with the grounding hub being configured to be electrically conductively connected at a second end to a shaft to be grounded, with the grounding hub being configured to electrically conductively connect the shaft to the electrical ground, and with the shaft being configured to be mounted by the bearing for rotation with respect to the grounding hub. The spring element is configured at one end to axially preload the grounding hub into electrically conductive connection with the electrical ground and at another end to axially preload the bearing.

### CROSS-REFERENCE TO RELATED APPLICATION

The present application is related and has right of priority to German Patent Application No. 10 2023 211 837.8 filed on Nov. 28, 2023, the entirety of which is incorporated by reference for all purposes.

### FIELD OF THE INVENTION

The invention relates generally to an arrangement for grounding a shaft, in particular a rotor shaft of an electric machine. The arrangement includes a grounding hub via which the shaft to be grounded is electrically conductively connected to an electrical ground, preferably a housing. A bearing is provided, via which the shaft to be grounded is mounted for rotation with respect to the grounding hub. The grounding hub is electrically conductively connected at one end to the ground and at the other end to the shaft to be grounded and is axially preloaded via a spring element. The invention also relates generally to a transmission, to an electric axle drive unit for a motor vehicle, and to an electric machine, in each of which an aforementioned arrangement is implemented.

### BACKGROUND

Electric machines are used in the automotive field for a motor vehicle to be a hybrid vehicle or an electric vehicle. Electric machines are also provided in some motor vehicle transmissions in order to make the motor vehicle transmission suitable for use in a hybrid vehicle or an electric vehicle. Whereas the remaining components of the transmission are enclosed and shielded by the surrounding transmission housing, shafts which extend out of the transmission housing can induce electromagnetic interference, which, in the region of a motor vehicle, can result in a malfunction of other electronic components. In addition, a potential difference can build up between the shaft and the transmission housing, which can result in perforations on bearings of the shaft and thus to a reduction in the service life of these bearings. For this reason, the shaft concerned is to be grounded, if possible. In other electric machines provided in a motor vehicle, such as in electric axle drive units, a particular shaft is also to be grounded in order to eliminate or reduce electromagnetic interference and to prevent the build-up of a potential difference. Grounding is usually carried out by electrically conductively connecting the shaft to be grounded to an electrical ground, which is usually a housing.

DE 10 2021 213 387 A1 describes an arrangement for grounding a shaft, wherein the shaft to be grounded in this arrangement is electrically conductively connected to a housing via a tubular grounding hub, which housing acts as an electrical ground for grounding the shaft. The shaft to be grounded is mounted via a bearing for rotation with respect to the grounding hub, wherein, via the bearing, in addition, an electrically conductive connection is established between the shaft to be grounded and one end of the grounding hub. At an axial end situated opposite thereto, the grounding hub is, in addition, floatingly mounted in a housing cover of the housing and is axially preloaded against the bearing by a spring element, wherein, via the spring element, in addition, the electrically conductive connection of the grounding hub to the housing cover and thus also to the housing is established. The spring element is a wave spring.

### SUMMARY OF THE INVENTION

Proceeding from the above-described prior art, the problem addressed by the present invention is that of providing an arrangement in which a reliable grounding of a shaft is achieved in the most compact manner possible.

According to the invention, an arrangement for grounding a shaft includes a grounding hub via which the shaft to be grounded is electrically conductively connected to an electrical ground. In addition, a bearing is provided, via which the shaft to be grounded is mounted for rotation with respect to the grounding hub. The grounding hub is electrically conductively connected at one end to the ground and at the other end to the shaft to be grounded, and is axially preloaded via a spring element.

A “shaft” as set forth in the invention refers, in principle, to a rotatable component which is provided for transmitting a rotational motion between components to be coupled. This shaft is, in some instances, integral with one or both component(s) to be coupled. Particularly preferably, the shaft to be grounded is a rotor shaft of an electric machine, which rotor shaft is provided for a corotational connection with a rotor of the electric machine. The rotor and the rotor shaft are, in some instances, formed in one piece or present as individual components which are separate and connected to one another for conjoint rotation. The electric machine is an integral part of a motor vehicle transmission. The shaft to be grounded can also be, in principle, any type of shaft, such as a transmission shaft.

In the arrangement according to the invention, the grounding hub is provided for electrically conductively connecting the shaft to be grounded to the electrical ground, in that the grounding hub is electrically conductively connected at one end to the shaft to be grounded and also electrically conductively connected at the other end to the electrical ground. The grounding hub is made of an electrically conductive material at least in contact regions of the electrically conductive connections with the electrical ground and with the shaft to be grounded as well as in an intermediate region connecting these contact regions. Preferably, the grounding hub is formed entirely of an electrically conductive material, however, which is, in particular, a metal material such as steel or aluminum.

The grounding hub has, as set forth in the invention, in particular, a rod-like shape, i.e., it is an elongate component, similar to a shaft, in order to establish the electrically conductive connection preferably axially between the shaft to be grounded and the electrical ground within the arrangement according to the invention. More preferably, the grounding hub is rotationally symmetrical. The grounding hub is, in the arrangement according to the invention, also arranged, in particular, in a stationary manner, i.e., it does not perform a rotational motion, for the purpose of which, more preferably, a rotation prevention means is associated with the grounding hub.

The electrical ground, with which the electrically conductive connection of the shaft to be grounded is established via the intermediate grounding hub, is, as set forth in the invention, an electrically conductive body, to which, in particular, the potential zero is assigned as reference potential. Preferably, this ground is a housing, wherein the electrically conductive connection of the grounding hub is specifically established at this housing, a housing part, or a component which is permanently electrically conductively connected thereto.

Within the scope of the invention, “axial” means an orientation towards an axis of rotation of the shaft, or a longitudinal axis of the grounding hub, whereas “radial” means an orientation in the diameter direction with a center lying on the axis of rotation, or the longitudinal axis.

An “electrically conductive” connection as set forth in the invention refers to a connection in which a current flow between the connected components is enabled. In the arrangement according to the invention, this electrically conductive connection is formed between the electrical ground and the grounding hub, and between the grounding hub and the shaft to be grounded, wherein this is implemented directly or indirectly via further, intermediate components.

The bearing via which the shaft to be grounded is mounted for rotation with respect to the grounding hub is, in particular, a radial bearing, wherein this radial bearing is preferably a ball bearing and, particularly preferably, a grooved ball bearing. Within the scope of the invention, the intermediate bearing could also be a different type of bearing, such as a roller bearing, or a plain bearing.

The spring element axially preloads the grounding hub axially against the electrically conductive connection with the ground and axially preloads the bearing. In other words, the spring element therefore implements at one end an axial preloading of the grounding hub with respect to the shaft to be grounded towards the electrically conductive connection at which the grounding hub is electrically conductively connected to the electrical ground. At the other end, the spring element axially preloads the bearing.

Such an embodiment of an arrangement for grounding a shaft has the advantage that, as a result, a more compact configuration of the arrangement is achieved in the region of the electrically conductive connection of the grounding hub with the ground, in that, in this region, there is no spring element preloading the grounding hub against the shaft to be grounded, but rather an electrical contact of the grounding hub with the ground is to be established. Therefore, the electrically conductive connection of the grounding hub with the ground can also be configured with a lower electrical resistance. At the same time, however, it is reliably ensured nevertheless via the spring element that the electrically conductive connection of the grounding hub to the ground is maintained, in that the spring element preloads the grounding hub against the electrically conductive connection with the ground, i.e., axially preloads the grounding hub against a contact point or a contact region, which is formed on the part of the electrical ground or a component which is permanently electrically conductively connected to the electrical ground. In addition, the spring element implements a preloading of the bearing, as a result of which a low-noise movement of the bearing is achieved.

For the axial preloading of the grounding hub as well as of the bearing, the spring element is supported axially on the part of the grounding hub as well as on the part of the shaft to be grounded, in order to axial preload the grounding hub with respect to the shaft to be grounded against the electrically conductive connection to the electrical ground as well as to axially preload the bearing. For this purpose, the spring element is to be positioned either between the shaft to be grounded and the bearing or between the bearing and the grounding hub.

Particularly preferably, in contrast to the arrangement described in DE 10 2021 213 387 A1, an electrically conductive connection is not established between the shaft to be grounded and the electrical ground via the axially preloading spring element, but rather the spring element is used in the arrangement according to the invention solely for the axial preloading of the grounding hub and of the bearing. As a result, the spring element does not need to be optimized with respect to electrical conductivity and can therefore have a simple configuration. Alternatively, it is also conceivable with respect to the arrangement according to the invention that the spring element is used not only for axially preloading the grounding hub and the bearing, but also for establishing an electrically conductive connection of the grounding hub to the shaft to be grounded. In this case, the spring element must then be configured to be electrically conductive, however, due to the material property thereof or due to a corresponding coating.

Preferably, the grounding hub is floatingly mounted with respect to the electrical ground. The grounding hub is therefore movable in this case axially with play with respect to the ground, as a result of which the axial preloading of the grounding hub against the electrically conductive connection to the ground is easily implemented via the spring element. This is the case because, as a result, the grounding hub is displaceable axially relative to the electrical ground and thus also preloaded via the spring element relative to the shaft to be grounded against the electrically conductive connection with the ground. In particular, for this purpose, the grounding hub forms a guide section on a subsection, at which guide section the grounding hub is axially displaceably guided with respect to the ground in a guide bore. As a result, the floating mounting of the grounding hub at the ground is easily achieved. Particularly preferably, the guide section is a cylindrical or tubular end of the grounding hub.

In particular, the grounding hub is tubular at least in sections and, via an internal volume, connects a ground-side supply connection for lubricant and/or coolant with the shaft to be grounded. As a result, in addition to establishing the electrically conductive connection between the shaft to be grounded and the ground, the grounding hub also performs the function of supplying lubricant and/or coolant to the shaft to be grounded, for the purpose of which the grounding hub is tubular at least in sections.

The lubricant and/or coolant can be guided via an internal volume of the grounding hub, which is formed as a tube at least in sections, and a supply line—which is defined as a result—to the shaft to be grounded, wherein the medium is preferably oil, which is provided for cooling the shaft, which is, in particular, a rotor shaft. The grounding hub is tubular at least over a portion of the axial extension thereof, in that, in the at least such tubular subsections of the grounding hub, an internal volume is delimited by the surrounding material of the grounding hub and thus the supply line is defined in this region. Particularly preferably, however, the grounding hub is entirely a tube, in order to therefore enable the lubricant and/or coolant to be supplied via the entire axial extension of the grounding hub and thus also to achieve guidance of the medium from the one axial end of the grounding hub to the other axial end.

The internal volume of the grounding hub is connectable to a radial outer region of the grounding hub via at least one bore. As a result, a portion of the lubricant and/or coolant conducted via the internal volume is directable into the radial outer region of the grounding hub, in order to also supply other components in addition to the shaft to be grounded, such as bearings and/or gears, etc. Particularly preferably, the at least one bore is provided axially in the proximity of the bearing. Furthermore, the at least one bore lies, in particular in the installed position of the grounding hub, vertically below in order to allow a portion of the lubricant and/or coolant to easily flow away via the at least one bore.

According to one embodiment of the invention, the spring element is supported axially with one side against the bearing. The spring element is therefore positioned adjacent to the bearing via which the shaft to be grounded is mounted for rotation with respect to the grounding hub, and the spring element rests with one end thereof directly axially against the bearing. This has the advantage that, as a result, the axial preloading of the grounding hub against the electrically conductive connection with the ground is implemented and the axial preloading of the bearing is also directly implemented.

In one development of the aforementioned embodiment, the spring element is supported axially at one end against the bearing and, at the other end, on the part of the grounding hub. In this case, the spring element therefore axially preloads the grounding hub against the electrically conductive connection to the ground, in that an axial support of the spring element against the bearing as well as an axial support on the part of the grounding hub is implemented. The support of the spring element on the part of the grounding hub is implemented directly against the grounding hub or indirectly, in that the spring element is supported axially against at least one intermediate component, which is connected to the grounding hub.

Preferably, at least one grounding hub-side bearing ring of the bearing is guided on the part of the grounding hub with a clearance fit, wherein a bearing seat, which is provided on the part of the grounding hub, of the grounding hub-side bearing ring is axially delimited on both sides. As a result, on the part of the grounding hub, an axial mobility with respect to the bearing is achieved, so that the axial preloading of the grounding hub against the electrically conductive connection with the ground is also easily implemented. In particular, the grounding hub-side bearing ring is an inner ring of the bearing. The axial delimitation of the bearing seat on both sides is implemented, in particular, by stops lying axially on both sides of the bearing ring. Particularly preferably, in addition, the shaft-side bearing ring, which is, in particular, an outer ring of the bearing, is guided on the part of the shaft to be grounded with a clearance fit in order to allow the bearing and the grounding hub to be installed together and to simplify this installation.

Alternatively to the aforementioned development, it is also conceivable within the scope of the invention that the spring element is arranged between the bearing and the shaft to be grounded and is supported against the bearing at one end and, at the other end, on the part of the shaft to be grounded. As a result thereof, in addition, a preloading of the bearing and a preloading of the grounding hub against the electrically conductive connection with the ground is implemented, in that the grounding hub is axially preloaded against the electrically conductive connection via the intermediate bearing. In this case, a shaft-side bearing ring would then need to be guided with clearance fit on the part of the shaft to be grounded.

According to one option of the invention, the electrically conductive connection of the grounding hub with the shaft to be grounded is established via a guide device, which is mounted on the grounding hub at an end facing the shaft to be grounded and is electrically conductively connected to the grounding hub. The guide device has a guide element, which is axially preloaded against the shaft to be grounded and electrically conductively connects the shaft to be grounded with the guide device. As a result, the electrically conductive connection of the grounding hub with the shaft to be grounded is implemented with a low electrical resistance, in that the connection is established via the intermediate guide device by utilizing a suitable guide element. Particularly preferably, the guide element used is an element having high electric conductivity, which guide element can be configured, in particular, as a graphite element.

In one development of the aforementioned option and in combination with the guidance of the grounding hub-side bearing ring on the part of the grounding hub with clearance fit, the bearing seat is formed on an outer circumference of the guide device, wherein the axial delimitation of the bearing seat on both sides is formed by the guide device. Apart from establishing the electrically conductive connection between the shaft to be grounded and the grounding hub, the guide device is therefore additionally used to configure the bearing seat, so that the ground hub-side bearing ring of the bearing is guided on the outer circumference of the guide device.

Particularly preferably, the bearing seat is delimited in a first axial direction via an abutment shoulder, which is formed around the outer circumference of the guide device and forms an axial abutment surface for the grounding hub-side bearing ring, wherein the bearing seat is formed in a second axial direction via a widening of an outer diameter of the guide device produced via shaping. This widening of the outer diameter of the guide device induced by shaping is brought about, for example, by a press-fit after the bearing ring has been placed onto the bearing seat. Such a configuration of the bearing seat could also be implemented in one conceivable embodiment of the invention, in which the bearing seat is provided on an outer circumference of the grounding hub.

In one embodiment of the invention, the spring element is axially supported on the part of the grounding hub against a support shoulder of the guide device. Therefore, due to the guide device, an axial abutment surface for the spring element is also provided, which spring element then preloads the guide device against the grounding hub and thus also preloads the grounding hub against the electrically conductive connection with the ground via the intermediate guide device. Such a support shoulder can instead be, however, within the scope of the invention, directly on the grounding hub, wherein the spring element is then also supported directly axially against the grounding hub.

Within the scope of the invention, it would also be conceivable, as an alternative, that a guide device is not provided, but rather that the bearing electrically conductively connects the grounding hub with the shaft to be grounded. In this case, the electrically conductive connection is therefore established between the grounding hub and the shaft to be grounded via the intermediate bearing, as a result of which the otherwise separate guide device is eliminated and thus the manufacturing complexity is reduced. The bearing is positioned between the grounding hub and the shaft to be grounded on a small diameter, as a result of which low peripheral speeds arise at the bearing. Due to these low peripheral speeds, an insulating effect of lubricant of the bearing is avoided, which otherwise also increasingly comes into play as the peripheral speed increases.

In one development of the invention, the spring element is a compression spring, preferably a helical spring. As a result, the axial preloading is implemented in a reliable manner, and a helical spring can also be arranged in a compact manner. Alternatively, the spring element is a disk spring or a wave spring, wherein the latter is achieved, in particular, when the electrically conductive connection between the grounding hub and the shaft to be grounded is established via the intermediate bearing. This is the case because the electrically conductive connection between the bearing and the grounding hub can be established in this case via the intermediate wave spring, wherein this is possible with a low contact resistance via the wave spring.

In another embodiment of the invention, the electrically conductive connection of the grounding hub with the ground is established at a guide section provided on the grounding hub, which guide section is preloaded against an abutment surface of the ground by the axial preloading of the grounding hub, which axial preloading is generated via the spring element, and establishes the electrically conductive connection of the grounding hub to the ground. Advantageously, as a result, the electrically conductive connection of the grounding hub to the electrical ground is implemented in a simple and, at the same time, reliable manner. Particularly preferably, the guide section projects in a radially outward direction with respect to the remainder of the grounding hub.

In one development of the aforementioned embodiment, the guide section is present as a separate, annular guide element, which is mounted via an inner diameter thereof on an outer diameter of the grounding hub. Due to the fact that the guide section is present as a separate component which is mounted on the grounding hub, a complex formation of such a section is eliminated on the part of the grounding hub.

As an alternative or in addition to the aforementioned development, the guide section also fixes the grounding hub in the direction of rotation. This simplifies—in particular in the embodiment of the invention, in which the grounding hub is tubular at least in sections and is used to guide lubricant and/or coolant—the flow of the lubricant and/or coolant via the grounding hub due to the absence of rotation of the grounding hub. The rotation prevention means is at least one rib which projects radially and extends in the circumferential direction over a subsection, which rib is formed on the guide element or on the ground and projects into a recess in each case, which recess is delimited on both sides of the at least one rib in the circumferential direction and is formed on the ground or on the guide element. As a result, rotation prevention is achieved easily by positive engagement. Particularly preferably, the at least one rib projects radially with respect to the rest of the guide section, whereas the associated recess is defined on the part of the ground, in particular by a corresponding configuration of the housing, which is the ground. In particular instances, the guide section is equipped with multiple ribs, particularly preferably with two ribs.

Particularly preferably, the guide section delimits displacements of the grounding hub in both axial directions due to interaction with the abutment surface of the ground as well as with a snap ring. The snap ring is positioned in a bore in the ground on the part of the electrical ground axially on a side of the guide section facing away from the abutment surface.

The invention also relates to a transmission, which is, in particular, a motor vehicle transmission, wherein, in this transmission, at least one shaft is grounded in an arrangement according to one or more of the aforementioned embodiments. This arrangement is formed, in particular, with a rotor shaft of an electric machine, which is integrated into the transmission. An arrangement according to the invention for grounding the shaft can also be an integral part of an electric drive axle unit for a motor vehicle or of an electric machine.

### BRIEF DESCRIPTION OF THE DRAWINGS

Advantageous embodiments of the invention, which are explained in the following, are shown in the drawings in which:

FIG. 1 shows a schematic view of a drive train of a motor vehicle;

FIG. 2 shows a sectional view of a transmission of the drive train shown in FIG. 1 in the region of an arrangement according to the invention, according to a first embodiment of the invention;

FIG. 3 shows a detailed view of a region of the arrangement shown in FIG. 2;

FIG. 4 shows a schematic view of a drive train of a motor vehicle; and

FIG. 5 shows a schematic view of an electric machine.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

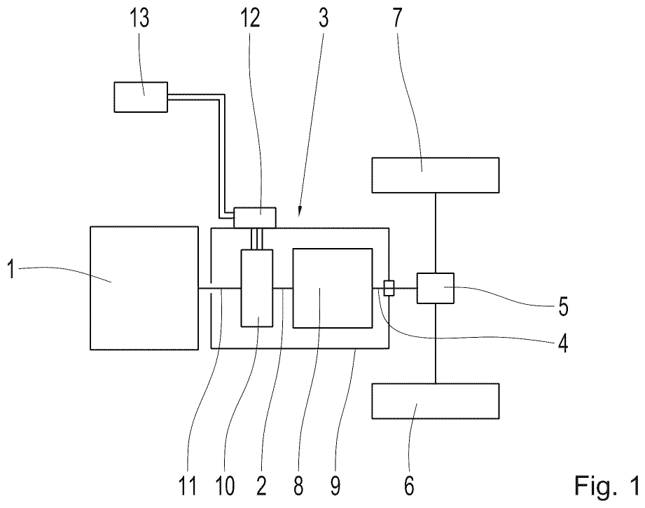

FIG. 1 shows a schematic view of a drive train for a motor vehicle. This drive train has an internal combustion engine 1, the output of which is coupled to an input shaft 2 of a transmission 3. An output shaft 4 of the transmission 3 is connected to a differential 5. The differential 5 is configured to distribute the power applied at the output shaft 4 to driving wheels 6, 7 of the motor vehicle. The transmission 3 has a gear set 8, which, together with shift elements of the transmission 3 not shown in FIG. 1, is configured to provide different transmission ratios between the input shaft 2 and the output shaft 4. The gear set 8 is enclosed in a housing 9, which also accommodates an electric machine 10, where the electric machine 10 is connected to the input shaft 2. The electric machine 10 is configured to drive the input shaft 2, wherein a shaft 11 as a rotor shaft of the electric machine 10 connects the input shaft 2 to the output of the internal combustion engine 1.

In addition, a power inverter 12 is mounted on the housing 9. One side of the power inverter 12 is connected to the electric machine 10 and another side of the power inverter 12 is connected to a battery 13. The power inverter 12 is utilized for converting the direct current of the battery 13 into an alternating current, which is suitable for operating the electric machine 10, and includes several power semiconductors for this purpose. The conversion between direct current and alternating current takes place by a pulse-like operation of the power semiconductors controlled by an open-loop system.

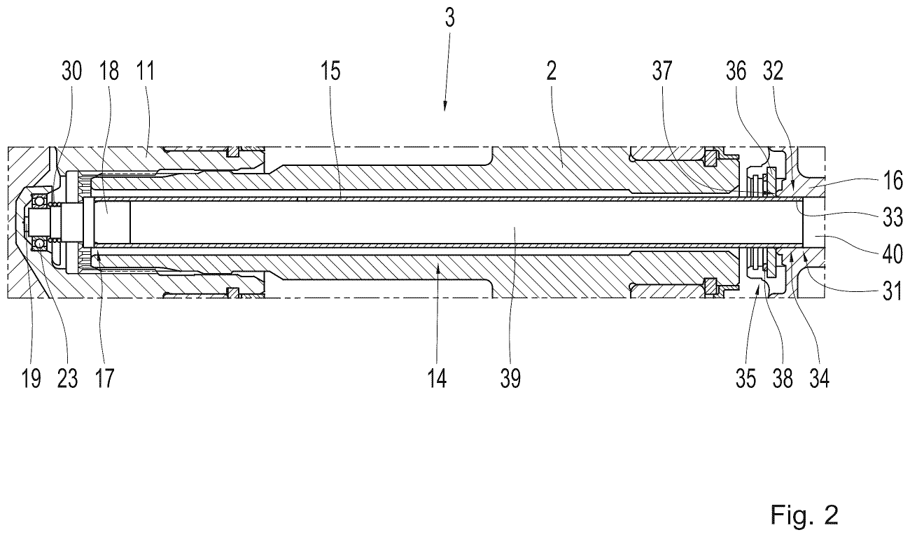

In order to prevent electromagnetic interference and the build-up of a potential difference during operation, the shaft 11 of the electric machine 10 is grounded in an arrangement 14, which is shown in FIG. 2. In FIG. 2, a permanently corotational connection between the input shaft 2 and the shaft 11 is apparent. The arrangement 14 for grounding the shaft 11, according to an embodiment of the invention, includes a stationary grounding hub 15, which is electrically conductively connected at one end to the shaft 11 and, at the other end, is electrically conductively connected to a housing cover 16 of the housing 9, where the housing 9 acts as an electrical ground in the arrangement 14.

The grounding hub 15 is a tubular body and extends axially from the housing cover 16 through the input shaft 2, which is a hollow shaft, into the shaft 11, which shaft 11 is also a hollow shaft at least in this region for this purpose. The grounding hub 15 is made of an electrically conductive material, such as aluminum.

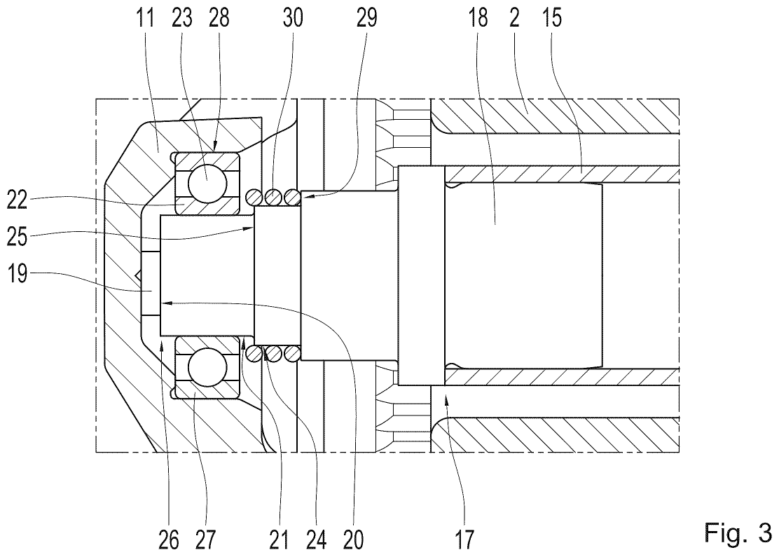

In addition, at one axial end 17 of the grounding hub 15, a guide device 18 (not shown in greater detail here) is mounted on the grounding hub 15. For this purpose, the guide device 18 is inserted into the tubular body of the grounding hub 15 at the end 17. Via the guide device 18, the electrically conductive connection of the shaft 11 to the grounding hub 15 is established. For this purpose, the guide device 18 is equipped with a guide element 19, which is preloaded axially against a contact surface 20 of the shaft 11 as is apparent, in particular, in the detailed view of the arrangement 14 in the region of the guide device 18 shown in FIG. 3. The guide element 19 of the guide device 18 consists (e.g., is made) of a material having high electric conductivity, for example, of graphite, and establishes the electrically conductive connection between the shaft 11 and the guide device 18 and thus, subsequently also the grounding hub 15.

As is also apparent in FIG. 2 and, in particular, in FIG. 3, an outer circumference of the guide device 18 forms a bearing seat 21 for a bearing ring 22 of a bearing 23 via which the shaft 11 is mounted for rotation with respect to the guide device 18 and thus also with respect to the stationary grounding hub 15. The bearing ring 22, which is an inner ring of the bearing 23, with the bearing 23 being a grooved ball bearing, is guided on the bearing seat 21 with a clearance fit, so that the guide device 18 is therefore displaceable axially relative to the bearing ring 22. This axial displaceability and thus also the bearing seat 21 are delimited in the one axial direction by an abutment shoulder 24, which is formed around the outer circumference of the guide device 18 and thereby forms an axial abutment surface 25 for the bearing ring 22. In the opposite axial direction, a delimitation of the axial displaceability and thus also of the bearing seat 21 is implemented by a widening 26—in comparison to the bearing seat 21—of an outer diameter of the guide device 18. This widening 26 has preferably been formed, for example by a press-fit, within the scope of a shaping process after the bearing ring 22 has been slid onto the bearing seat 21.

A bearing ring 27—as an outer ring—of the bearing 23 is also guided with a clearance fit in a receiving bore 28 in the shaft 11, in order to be able to install the bearing 23 together with the grounding hub 15 and the guide device 18 within the scope of assembly of the arrangement 14. In this connection, the bearing 23 arranged on the guide device 18 is then inserted with the bearing ring 27 into the receiving bore 28.

As a distinguishing feature, a spring element 30 is provided axially between the bearing 23 and a support shoulder 29 of the guide device 18, which spring element 30 is supported axially at one end against the bearing ring 22 of the bearing 23 and, at the other end, against the support shoulder 29. Via the spring element 30, which is a compression spring, such as a helical spring in the present case, the grounding hub 15 is preloaded together with the guide device 18 in relation to the bearing 23 and the shaft 11 towards the housing cover 16, wherein this axial preloading additionally results in a preloading of the bearing 23. The support shoulder 29 is formed around the outer circumference of the guide device 18.

As is apparent in FIG. 2, the grounding hub 15 is floatingly mounted in the housing cover 16 at an axial end 31 situated opposite the axial end 17. This floating mounting is implemented at a guide section 32, which is formed by a tube end 33 of the grounding hub 15, which tube end also forms the axial end 31. On the part of the housing cover 16, the grounding hub 15 is axially displaceably guided by the guide section 32 on a guide bore 34 in the housing cover 16.

At the axial end 31, the grounding hub 15 is additionally electrically conductively connected to the housing cover 16 at a guide section 35, wherein the guide section 35 is a separate, annular guide element 36, which is mounted via an inner diameter thereof on an outer diameter of the grounding hub 15. The guide element 36 is preferably pressed onto the grounding hub 15 into the corresponding region. Due to the axial preloading via the spring element 30, the guide element 36 is preloaded axially against an abutment surface 37 of the housing cover 16. The guide element 36 consists (e.g., is made) of an electrically conductive material, so that, due to the axial support of the guide element 36 against the abutment surface 37, an electrically conductive connection is established between the housing cover 16 and the grounding hub 15. The material of the guide element 36 is the same as the material of the grounding hub 15 or is a material having higher strength.

In addition to establishing the electrically conductive connection between the grounding hub 15 and the housing cover 16, the guide element 36 is also used for preventing rotation of the grounding hub 15 with respect to the housing cover 16 and for delimiting axial displacements of the grounding hub 15 with respect to the housing cover 16. In the one axial direction, this delimitation is implemented via interaction of the guide element 36 with the abutment surface 37, whereas a delimitation in the other axial direction is implemented via interaction of the guide element 36 with a snap ring 38, which is accommodated in the housing cover 16.

Apart from establishing the electrically conductive connection between the shaft 11 to be grounded and the housing cover 16, the grounding hub 15 is also used to supply lubricant and/or coolant to the shaft 11 to be grounded, in order to cool the shaft 11 and, in particular, the rotor of the electric machine. The lubricant and/or coolant is preferably oil. The lubricant and/or coolant is introduced from the axial end 31 into an internal volume 39 of the grounding hub 15, in that a supply connection 40 for the lubricant and/or coolant is formed in the housing cover 16 on the end face of the grounding hub 15.

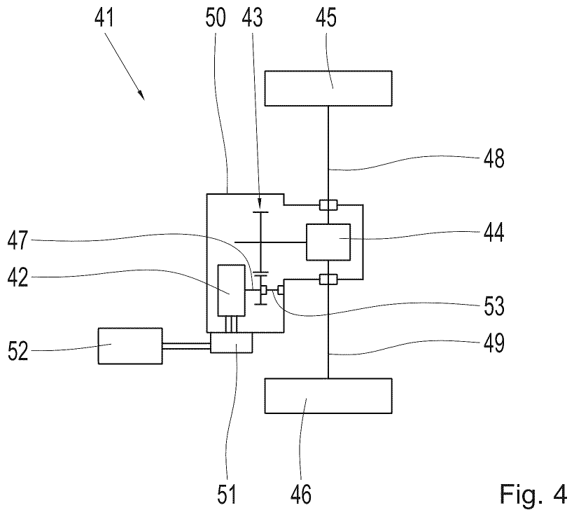

FIG. 4 shows a schematic view of a drive train for a motor vehicle, which, in contrast to FIG. 1, is a purely electric drive train. The drive train has an electric axle drive unit 41. The electric drive axle unit 41 includes an electric machine 42, the power of which is transmitted onto driving wheels 45, 46 of a motor vehicle via a reduction gear set 43 and a differential 44. For this purpose, the electric machine 42 is connected at the output end thereof at a shaft 47 to the reduction gear set 43. Output shafts 48, 49 of the differential 44 are connected to the driving wheels 45, 46. The electric machine 42, the reduction gear set 43, and the differential 44 are enclosed in a housing 50. A power inverter 51 is mounted on the housing 50. One side of the power inverter 51 is connected to the electric machine 42 and another side of the power inverter 51 is connected to a battery 52. The power inverter 51 is utilized for converting the direct current of the battery 52 into an alternating current, which is suitable for operating the electric machine 42, and includes several power semiconductors for this purpose. The conversion between direct current and alternating current takes place by a pulse-like operation of the power semiconductors controlled by an open-loop system.

In the present case, a grounding of the shaft 47 is implemented within the framework of an arrangement according to the invention, which arrangement is similar to the arrangement according to FIGS. 2 and 3. A grounding hub 53 is also provided here, which grounding hub is preloaded against the housing 50 via a spring element. Reference is made to FIGS. 2 and 3 in this regard for the more precise configuration of the arrangement for grounding the shaft 47.

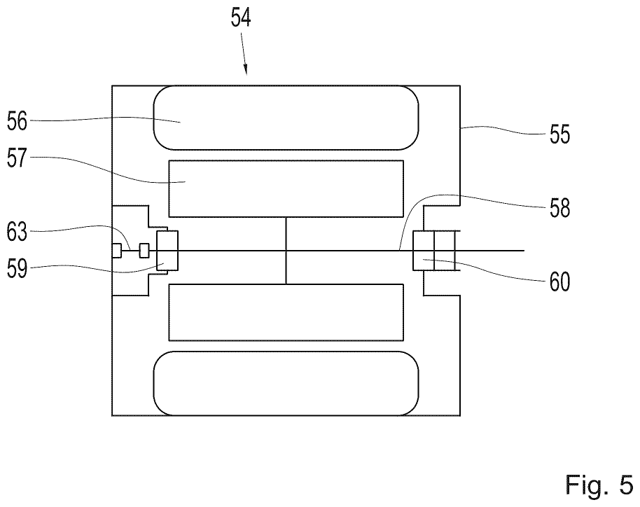

Finally, FIG. 5 shows a schematic view of an electric machine 54. The electric machine 54 has a housing 55, which accommodates a stator 56 and a rotor 57. The stator 56 is non-rotatably fixed in the housing 55. The rotor 57 is coupled to a rotor shaft 58, which rotor shaft 58 is rotatably mounted via two roller bearings 59, 60, which are supported against the housing 55. One end of the rotor shaft 58 projects out of the housing 55.

In the present case, the rotor shaft 58 is grounded within the framework of an arrangement according to the invention, which arrangement is similar to one of the arrangement according to FIGS. 2 and 3. A grounding hub 63 is also provided here, which grounding hub is preloaded against the housing 55 via a spring element. Reference is made to FIGS. 2 and 3 in this regard for the more precise configuration of the arrangement for grounding the rotor shaft 58.

A reliable grounding of a shaft is achieved by the embodiment of an arrangement according to the invention.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 internal combustion engine
2 input shaft
3 transmission
4 output shaft
5 differential
6 driving wheel
7 driving wheel
8 gear set
9 housing
10 electric machine
11 shaft
12 power inverter
13 battery
14 arrangement
15 grounding hub
16 housing cover
17 end
18 guide device
19 guide element
20 contact surface
21 bearing seat
22 bearing ring
23 bearing
24 abutment shoulder
25 abutment surface
26 widening
27 bearing ring
28 receiving bore
29 support shoulder
30 spring element
31 end
32 guide section
33 tube end
34 guide bore
35 guide section
36 guide element
37 abutment surface
38 snap ring
39 internal volume
40 supply connection
41 axle drive unit
42 electric machine
43 reduction gear set
44 differential
45 driving wheel
46 driving wheel
47 shaft
48 output shaft
49 output shaft
50 housing
51 power inverter
52 battery
53 grounding hub
54 electric machine
55 housing
56 stator
57 rotor
58 rotor shaft
59 roller bearing
60 roller bearing
61 grounding hub
62 arrangement
63 grounding hub

1-16: (canceled)

17. An arrangement (14) for grounding rotor shafts (11) of electric machines (10; 42; 54), the arrangement (14) comprising:
a bearing (23);
a grounding hub (15), the grounding hub (15) being configured to be electrically conductively connected at a first end to an electrical ground (9), the grounding hub (15) being configured to be electrically conductively connected at a second end to a shaft (11) to be grounded, the grounding hub (15) being configured to electrically conductively connect the shaft (11) to the electrical ground (9), the shaft (11) being configured to be mounted by the bearing (23) for rotation with respect to the grounding hub (15); and
a spring element (30), the spring element (30) being configured at one end to axially preload the grounding hub (15) into electrically conductive connection with the electrical ground (9) and at another end to axially preload the bearing (23).

18. The arrangement (14) of claim 17, wherein the spring element (30) is supported with one side axially against the bearing (23).

19. The arrangement (14) of claim 18, wherein the spring element (30) is axially supported at the other end against the bearing (23) and is axially supported at the one end on part of the grounding hub (15).

20. The arrangement (14) of claim 19, wherein at least one grounding hub-side bearing ring (22) of the bearing (23) is guided with a clearance fit on the part of the grounding hub (15), and
wherein a bearing seat (21) on the part of the grounding hub (15) is axially delimited, the grounding hub-side bearing ring (22) being seated on the bearing seat (21).

21. The arrangement (14) of claim 20, further comprising a guide device (18) configured for electrically conductively connecting the grounding hub (15) with the shaft (11), the guide device (18) being mounted on an end (17) of the grounding hub (15) facing the shaft (11), the guide device (18) being electrically conductively connected to the grounding hub (15), the guide device (18) having a guide element (19), the guide element (19) being axially preloaded against the shaft (11) and electrically conductively connecting the shaft (11) with the guide device (18).

22. The arrangement (14) of claim 21, wherein the bearing seat (21) is formed on an outer circumference of the guide device (18), wherein the bearing seat (21) is axially delimited by the guide device (18).

23. The arrangement (14) of claim 22, wherein the bearing seat (21) is delimited in a first axial direction via an abutment shoulder (24), the abutment shoulder (24) being formed around the outer circumference of the guide device (18) and defining an axial abutment surface (25) for the grounding hub-side bearing ring (22),
wherein the bearing seat (21) is delimited in a second axial direction via a portion (26) of the guide device (18), the portion (26) of the guide device (18) having a widened outer diameter produced via shaping.

24. The arrangement (14) of claim 21, wherein the spring element (30) is supported axially at the one end against a support shoulder (29) of the guide device (18) on the part of the grounding hub (15).

25. The arrangement (14) of claim 17, wherein the spring element (30) is a compression spring.

26. The arrangement (14) of claim 25, wherein the compression spring is a helical spring.

27. The arrangement (14) of claim 17, wherein the grounding hub (15) is configured to be in electrically conductive connection with the electrical ground (9) at a guide section (35) on the grounding hub (15), the guide section (35) being preloaded against an abutment surface (37) of the electrical ground (9) by the spring element (30) axially preloading the grounding hub (15), the grounding hub (15) being configured to be electrically conductively connected to the electrical ground (9) by the guide section (35).

28. The arrangement (14) of claim 27, wherein the guide section (35) is an annular guide element (36), the annular guide element (36) being separate from the grounding hub (15), an inner diameter of the annular guide element (36) being mounted on an outer diameter of the grounding hub (15).

29. The arrangement (14) of claim 27, wherein the guide section (35) fixes the grounding hub (15) in a direction of rotation.

30. The arrangement (14) of claim 27, wherein the guide section (35) delimits displacement of the grounding hub (15) in a first axial direction by interaction at a first side of the guide section (35) with the abutment surface (37) of the electrical ground (9) and delimits displacement of the grounding hub (15) in a second axial direction by interaction at a second side of the guide section (35) with a snap ring (38).

31. A transmission (3) for a motor vehicle, the transmission (3) comprising:
at least one shaft (11); and
the arrangement (14) of claim 17, the at least one shaft (11) being grounded by the arrangement (14).

32. An electric drive axle unit (41) for a motor vehicle, the electric drive axle unit (41) comprising:
a shaft (47); and
the arrangement (14) of claim 17, the shaft (47) being grounded by the arrangement (14).

33. An electric machine (54), the electric machine (54) comprising:
a stator (56), the stator (56) being non-rotatable;
a rotor (57), the rotor (57) being rotatable relative to the stator (56);
a rotor shaft (58) coupled to the rotor (57); and
the arrangement (14) of claim 17, the rotor shaft (58) being grounded by the arrangement (14).
